(19) United States
(12) Patent Application Publication
(10) Pub. No.: US 2024/0144699 A1
(43) Pub. Date: May 2, 2024

(54) VEHICLE

(71) Applicant: TOYOTA JIDOSHA KABUSHIKI KAISHA, Toyota-shi Aichi-ken (JP)

(72) Inventors: Masaaki SATO, Susono-shi Shizuoka-ken (JP); Takeru SHIRASAWA, Sunto-gun Shizuoka-ken (JP); Teruaki HAIBARA, Ashigara-gun Kanagawa-ken (JP); Kenji HOSHI, Gotemba-shi Shizuoka-ken (JP)

(73) Assignee: TOYOTA JIDOSHA KABUSHIKI KAISHA, Toyota-shi Aichi-ken (JP)

(21) Appl. No.: 18/379,211

(22) Filed: Oct. 12, 2023

(30) Foreign Application Priority Data
Oct. 31, 2022 (JP) 2022-174428

(51) Int. Cl. G06V 20/58; B60Q 9/00; B60R 1/074; B60W 30/06; E05F 15/73; G06V 20/56

(52) U.S. Cl. CPC G06V 20/586; B60Q 9/008; B60R 1/074; B60W 30/06; E05F 15/73; G06V 20/588; B60W 2420/42; E05Y 2400/44; E05Y 2900/55

(57) ABSTRACT

A vehicle includes an object sensor configured to detect an object around the vehicle; a warning device configured to alert a driver when an object is detected by the object sensor at a position at which a distance from the vehicle is less than or equal to a threshold; a receiver; and a controller configured to reduce the threshold when the receiver receives a signal transmitted from a vehicle washer.

### CROSS-REFERENCE TO RELATED APPLICATIONS

This application claims priority from Japanese Patent Application No. 2022-174428 filed on Oct. 31, 2022. The entire content of the priority application is incorporated herein by reference.

### BACKGROUND ART

Techniques disclosed herein relate to vehicles.

Japanese Patent Application Publication No. 2017-074817 describes a vehicle washer. A vehicle can be washed by activating the vehicle washer after the vehicle is parked in a parking space of the vehicle washer.

### SUMMARY

There are vehicles having a detection function for environments around the vehicles, such as object sensors and camera-implemented image recognition. However, environments around vehicle washers differ from typical environments in which vehicles travel (e.g., roads, parking lots, etc.), and thus when a vehicle is moved toward/into a vehicle washer, the detection function may not work appropriately. The disclosure herein proposes vehicles capable of appropriately activating a detection function for environment when moved toward/into a vehicle washer.

A first vehicle disclosed herein may comprise an object sensor configured to detect an object around the vehicle, a warning device configured to alert a driver when an object is detected by the object sensor at a position at which a distance from the vehicle is less than or equal to a threshold, a receiver, and a controller configured to reduce the threshold when the receiver receives a signal transmitted from a vehicle washer.

When a vehicle is to be parked in a vehicle washer, the vehicle approaches the vehicle washer. Thus, if the driver is alerted by the object sensor under the same conditions as in the typical environment, the driver is alerted more than unnecessary. On the other hand, in this vehicle, when the receiver receives the signal transmitted from the vehicle washer while the vehicle is moved toward/into the vehicle washer, the controller reduces the threshold (i.e., the distance between the vehicle and an object based on which the driver is alerted). Therefore, it is possible to prevent the driver from being alerted more than necessary.

A second vehicle disclosed herein may comprise a camera configured to capture an image of a road surface around the vehicle, an automatic parking device configured to recognize a parking frame from the image captured by the camera according to a recognition criterion and move the vehicle into the recognized parking frame, a receiver, and a controller configured to change the recognition criterion when the receiver receives a signal transmitted from a vehicle washer.

The recognition criterion is a condition for recognizing the parking frame in the image. The recognition criterion may include, for example, the shape of the parking frame, the width of the parking frame, and the color of the parking frame.

The environment around the parking space of the vehicle washer differs greatly from environments around typical parking spaces (e.g., parking lots). Therefore, if the automatic parking device operates according to the same recognition criterion as that for the typical environments when the vehicle is to be parked in the vehicle washer, the automatic parking device may not be able to recognize the parking frame of the vehicle washer. On the other hand, in this vehicle, when the receiver receives the signal transmitted from the vehicle washer while the vehicle is moved to be parked in the vehicle washer, the controller changes the recognition criterion. The automatic parking device thus can park the vehicle in the parking frame.

### BRIEF DESCRIPTION OF THE DRAWINGS

FIG. 1 is a perspective view of a vehicle and a washer.

FIG. 2 is a block diagram for a vehicle according to a first embodiment.

FIG. 3 is a flowchart showing a vehicle washing process according to the first embodiment.

FIG. 4 is a block diagram for a vehicle according to a second embodiment.

FIG. 5A is an explanatory diagram for automatic parking.

FIG. 5B is an explanatory diagram for automatic parking.

FIG. 6 is a flowchart showing a vehicle washing process according to the second embodiment.

### DETAILED DESCRIPTION OF EMBODIMENTS

The above-described first vehicle may further comprise a window that is openable and a door mirror that is foldable. The controller may be configured to perform a process of closing the window and folding the door mirror when the receiver receives the signal.

According to this configuration, it is possible to facilitate preparation for vehicle washing.

In the first vehicle described above, the object sensor may comprise a right object sensor configured to detect an object on a right side of the vehicle and a left object sensor configured to detect an object on a left side of the vehicle. The warning device may comprise a display device configured to display, when an object is detected by the object sensor, whether the detected object is present on the left side or the right side of the vehicle.

According to this configuration, the driver can recognize which of the left side and the right side is approaching the vehicle washer.

The above-described second vehicle may further comprise a window that is openable and a door mirror that is foldable. The controller may be configured to perform a process of closing the window and folding the door mirror when the receiver receives the signal.

According to this configuration, it is possible to facilitate preparation for vehicle washing.

### First Embodiment

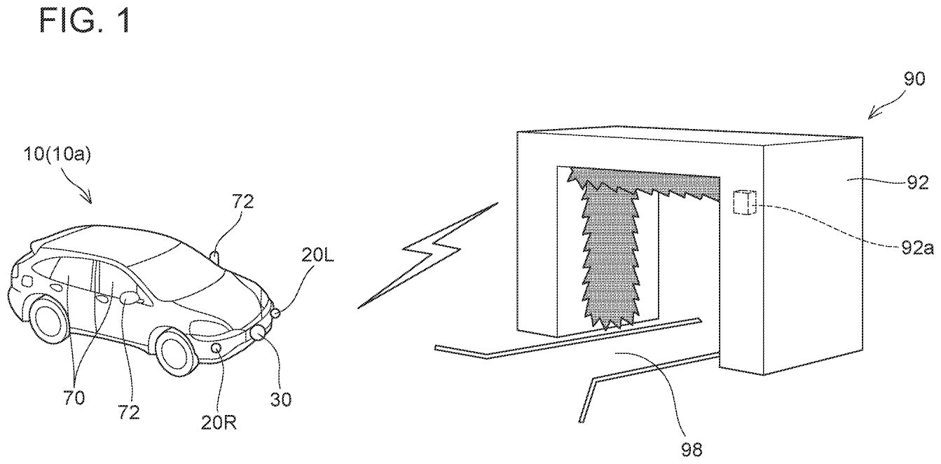

FIG. 1 shows a vehicle 10 of a first embodiment. The vehicle 10 may be an engine-driven vehicle or an electric vehicle. FIG. 1 also shows a vehicle washer 90. The vehicle washer 90 comprises a main body 92. The main body 92 has a gate-like shape that surrounds top and lateral portions of a parking space 98. By parking the vehicle 10 in the parking space 98 and then activating the vehicle washer 90, the vehicle 10 can be washed by the vehicle washer 90. The main body 92 comprises a control unit 92a. The control unit 92a comprises a radio communication device. The control unit 92a can communicate with the vehicle 10. The vehicle washer 90 comprises a plurality of vehicle sensors configured to detect a vehicle around the parking space 98, although this is not shown. Each of the vehicle sensors is connected to the control unit 92a via a communication line.

As shown in FIG. 1, the vehicle 10 comprises a right object sensor 20R and a left object sensor 20L. Although a front camera 30 is illustrated in FIG. 1, the vehicle 10 may not comprise the front camera 30. The right object sensor 20R and the left object sensor 20L are configured to detect objects that are present around the vehicle 10. For example, a millimeter-wave radar, an ultrasonic sensor, an optical sensor (e.g., a LiDAR, etc.), etc. can be used as the right object sensor 20R and the left object sensor 20L. The right object sensor 20R and the left object sensor 20L may be referred to as clearance sonars, corner sensors, etc. The right object sensor 20R detects an object at a right front portion of the vehicle 10. The left object sensor 20L detects an object at a left front portion of the vehicle 10.

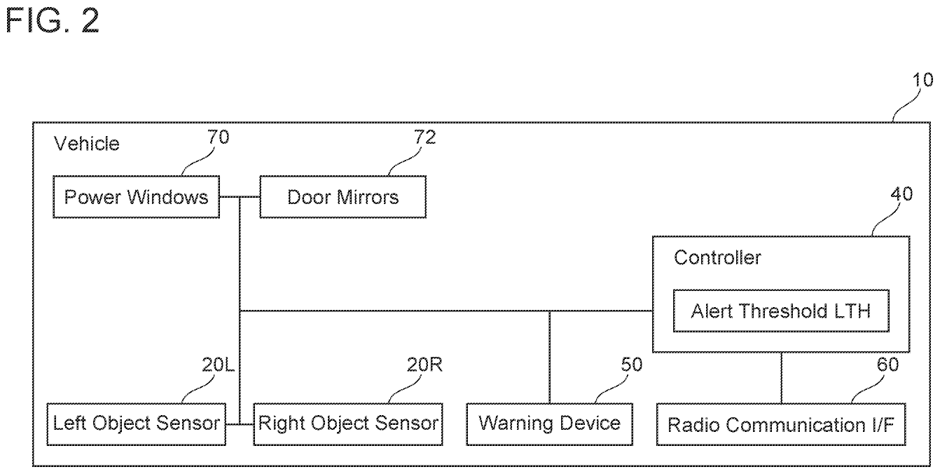

FIG. 2 shows devices mounted on the vehicle 10. As shown in FIG. 2, the vehicle 10 comprises a controller 40. The controller 40 includes a CPU, RAM, ROM, etc. In FIG. 2, the controller 40 is indicated by a single block, however, the controller 40 may be configured by a plurality of ECUs (Electric Control Units) dispersedly arranged inside the vehicle 10. The object sensors 20R, 20L are connected to the controller 40 via communication lines such as communication buses. Each of the object sensors 20R, 20L outputs, when not detecting any objects, a signal indicating that an object is not detected. Each of the object sensors 20R, 20L also outputs, when detecting an object, the distance from the vehicle 10 to the object. Hereinafter, a distance to an object calculated by the right object sensor 20R is referred to as a distance LR, and a distance to an object calculated by the left object sensor 20L is referred to as a distance LL. The object sensors 20R, 20L transmit their outputs to the controller 40 at a predetermined cycle.

The vehicle 10 comprises a warning device 50. The warning device 50 is connected to the controller 40 via a communication line, and is configured to alert a driver of the vehicle 10 in accordance with commands from the controller 40. Alerts by the warning device 50 may include a visual alert, an auditory alert, or the both. For example, a monitor, a projector for projection onto a windshield, an indicator lamp, a speaker, or the like can be used as the warning device 50.

The controller 40 stores an alert threshold LTH. Also, as described above, the controller 40 repeatedly receives, from the object sensors 20R, 20L, their outputs. When objects are detected by the object sensors 20R, 20L, the controller 40 receives the distances LR, LL to the objects. When the controller 40 receives the distances LR, LL, the controller 40 determines whether or not the distances LR, LL are equal to or less than the alert threshold LTH. If at least one of the distance LR and the distance LL is equal to or less than the alert threshold LTH, the controller 40 alerts the driver via the warning device 50. In this way, when the object sensor(s) 20R and/or 20L detect(s) that object(s) is/are present at a distance less than or equal to the alert threshold LTH, the driver is alerted by the warning device 50. Thus, the driver can recognize that the vehicle 10 is approaching the object.

In addition, when the warning device 50 alerts the driver, it may inform the driver which of the left and right sides of the vehicle 10 is approaching the object. That is, when the distance LR is equal to or less than the alert threshold LTH, the warning device 50 may inform that the right front portion of the vehicle 10 is approaching the object, and/or when the distance LL is equal to or less than the alert threshold LTH, the warning device 50 may inform that the left front portion of the vehicle 10 is approaching the object. For example, the warning device 50 may inform whether the object is present on the left side or the right side of the vehicle 10 by displaying that on a monitor or in an audible manner. Alternatively, direction indicator lamps provided on door mirrors 72 may be used as the warning device 50. In this case, when an object is present on the right side of the vehicle 10, the direction indicator lamp of the right door mirror 72 may be turned on, and when an object is present on the left side of the vehicle 10, the direction indicator lamp of the left door mirror 72 may be turned on.

The controller 40 can change the alert threshold LTH between a first alert threshold LTH1 and a second alert threshold LTH2. The second alert threshold LTH2 is less than the first alert threshold LTH1. In normal times, the alert threshold LTH is set to the first alert threshold LTH1.

The vehicle 10 comprises a radio communication interface 60. The radio communication interface 60 is connected to the controller 40 via a communication line. The controller 40 can communicate with the control unit 92a of the vehicle washer 90 via the radio communication interface 60.

The vehicle 10 comprises power windows 70 and door mirrors 72. The power windows 70 and the door mirrors 72 are connected to the controller 40 via communication lines. The controller 40 can open and close the power windows 70. The controller 40 can also fold and unfold the door mirrors 72.

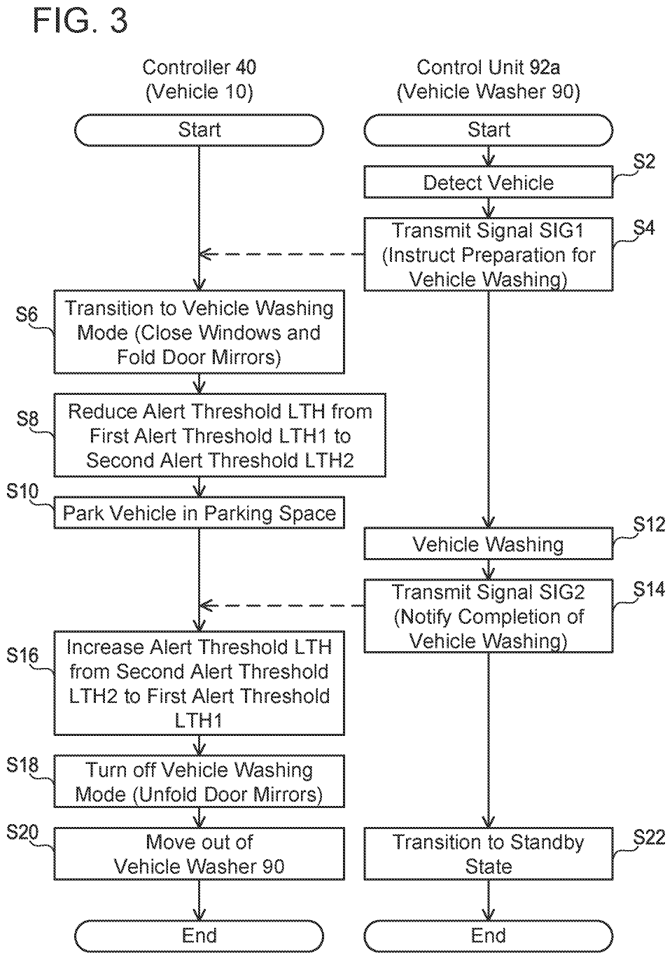

Next, how the vehicle 10 operates when the vehicle 10 is to be parked in the parking space 98 of the vehicle washer 90 will be described with reference to FIG. 3. As described above, in normal times, the alert threshold LTH is set to the first alert threshold LTH1. Therefore, at the start of the process of FIG. 3, the alert threshold LTH is set to the first alert threshold LTH1.

As the vehicle 10 approaches the entrance of the vehicle washer 90, the vehicle washer 90 detects the vehicle 10 by the vehicle sensors (not shown) in step S2 of FIG. 3. Then, in step S4, the control unit 92a transmits, to the controller 40 of the vehicle 10, a signal SIG1 that instructs preparation for vehicle washing.

The controller 40 of the vehicle 10, when receiving the signal SIG1, causes the vehicle 10 to transition to a vehicle washing mode in step S6. The vehicle washing mode is a mode of the vehicle 10 that is suitable for washing by a vehicle washer. More specifically, in step S6, the controller 40 closes all the power windows 70. This prevents washing water from entering the interior of the vehicle 10 in the subsequent vehicle washing. In addition, in step S6, the controller 40 folds the left and right door mirrors 72. Also, in step S6, the controller 40 transitions to a mode in which an air conditioner and audio instruments are usable even in an ignition-off state. Therefore, during the subsequent vehicle washing, the driver can use the air conditioner and the audio instruments even in the ignition-off state.

Next, the controller 40 reduces the alert threshold LTH from the first alert threshold LTH1 to the second alert threshold LTH2 in step S8.

When steps S6, S8 are completed, the controller 40 instructs the driver to move the vehicle 10 toward/into the parking space 98 via a monitor or the like. The driver then moves the vehicle 10 toward/into the parking space 98 in step S10. At this time, the vehicle 10 approaches the main body 92 of the vehicle washer 90. Thus, the object sensors 20R, 20L detect the main body 92 and transmit the distances LR, LL to the main body 92 (i.e., spacing between the vehicle 10 and the main body 92). Even when the vehicle 10 is moved along a proper route toward/into the parking space 98, the distances LR, LL may become less than the first alert threshold LTH1. In step S8, however, the alert threshold LTH has been reduced from the first alert threshold LTH1 to the second alert threshold LTH2. When the vehicle 10 is moved along the proper route toward/into the parking space 98, the distances LR, LL will not become equal to or less than the second alert threshold LTH2. Therefore, if the vehicle 10 is moved along the proper route toward/into the parking space 98 in step S10, the warning device 50 does not alert the driver. As described above, since the alert threshold LTH is reduced, issuance of an alert is prevented when the vehicle 10 is moved along the proper route toward/into the parking space 98. When the vehicle 10 is moved along an improper route and the distances LR, LL become less than the second alert threshold LTH2, the controller 40 alerts the driver via the warning device 50. This prevents the vehicle 10 from hitting the main body 92. Since the vehicle 10 is slowly moved toward/into the parking space 98 of the vehicle washer 90, it is possible to prevent the hitting of the vehicle 10 even when the alert threshold LTH is set to the reduced second alert threshold LTH2. In addition, when the warning device 50 alerts the driver, as described above, the warning device 50 informs the driver which of the left and right sides of the vehicle 10 is approaching the main body 92. Thus, the driver is able to know which of the left and right sides of the vehicle 10 is approaching the main body 92.

The movement of the vehicle 10 in step S10 may be implemented by automatic parking instead of driving by the driver. Even in this case, unnecessary alerts can be prevented since the alert threshold LTH is reduced to the second alert threshold LTH2.

Once the vehicle 10 is parked in the parking space 98, the vehicle washer 90 detects the parking of the vehicle 10 by the vehicle sensors (not shown). Then, in step S12, the control unit 92a causes the vehicle washer 90 to perform vehicle washing. When the vehicle washing is completed, the control unit 92a transmits a signal SIG2 that notifies the completion of the vehicle washing to the controller 40 of the vehicle 10 in step S14.

The controller 40 of the vehicle 10, when receiving the signal SIG2, increases the alert threshold LTH from the second alert threshold LTH2 to the first alert threshold LTH1 in step S16. That is, the alert threshold LTH is returned from the value for vehicle washing to the value for normal times.

The controller 40 then turns off the vehicle washing mode in step S18. More specifically, in step S18, the ignition is turned on, and the controller 40 unfolds the left and right door mirrors 72. Also, in step S18, the controller 40 transitions to a mode in which the air conditioner and the audio instruments are unusable in the ignition-off state.

As described above, after the vehicle washing is completed, the vehicle 10 returns to the normal traveling mode in steps S16, S18. The driver then moves the vehicle 10 out of the vehicle washer 90 in step S20. Then, the vehicle washer 90 detects the movement of the vehicle 10 by the vehicle sensors (not shown), and transitions to a standby state in step S22.

As described above, the vehicle 10 reduces the alert threshold LTH from the first alert threshold LTH1 to the second alert threshold LTH2 when moved toward/into the parking space 98 of the vehicle washer 90. Thus, unnecessary alerts can be prevented as the vehicle 10 is approaching the vehicle washer 90. In addition, the transition to the vehicle washing mode can be implemented in accordance with the change in the alert threshold LTH, and preparation for the vehicle washing is facilitated.

### Second Embodiment

A vehicle 10a of a second embodiment shown in FIG. 1 includes a front camera 30. Although the object sensors 20R, 20L are illustrated in FIG. 1, the vehicle 10a of the second embodiment may or may not include the object sensors 20R, 20L. The front camera 30 captures images of a road surface ahead of the vehicle 10a.

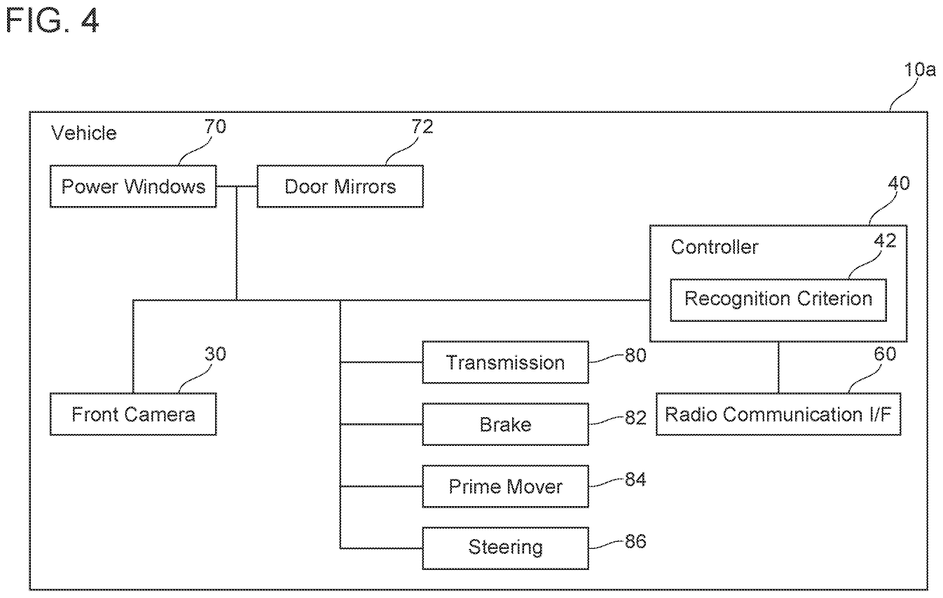

FIG. 4 shows devices mounted on the vehicle 10a. Since the configurations of power windows 70 and door mirrors 72 shown in FIG. 4 are the same as those of the first embodiment, the description thereof will be omitted.

The vehicle 10a comprises a controller 40. The controller 40 includes a CPU, RAM, ROM, etc. as in the first embodiment. The front camera 30 is connected to the controller 40 via a communication line such as a communication bus. The front camera 30 repeatedly transmits an image of the road surface ahead of the vehicle 10a to the controller 40. Further, the controller 40 can communicate with the control unit 92a of the vehicle washer 90 via a radio communication interface 60. The controller 40 is also connected to a transmission 80, a brake 82, a prime mover 84 (e.g., an engine or a motor), and a steering 86 of the vehicle 10a via communication lines, and can control them. The controller 40 can perform automatic parking by controlling them. In the automatic parking, the controller 40 switches forward movement and rearward movement of the vehicle 10a by the transmission 80, controls the vehicle speed via the brake 82 and the prime mover 84, and controls the traveling direction of the vehicle 10a via the steering 86. In addition, the controller 40 stores, as data, a recognition criterion 42 for recognizing a parking frame in the automatic parking. The controller 40 can change the recognition criterion 42 between a first recognition criterion 42a and a second recognition criterion 42b. The first recognition criterion 42a is a recognition criterion used in normal times. The second recognition criterion 42b is a recognition criterion used for parking the vehicle in the parking space 98 of the vehicle washer 90.

When the driver performs a predetermined operation, the controller 40 performs the automatic parking. In the automatic parking, the controller 40 receives images captured by the front camera 30 and recognizes, from the received images, a parking frame indicating the contour of the parking space. The controller 40 recognizes the parking space according to the recognition criterion 42.

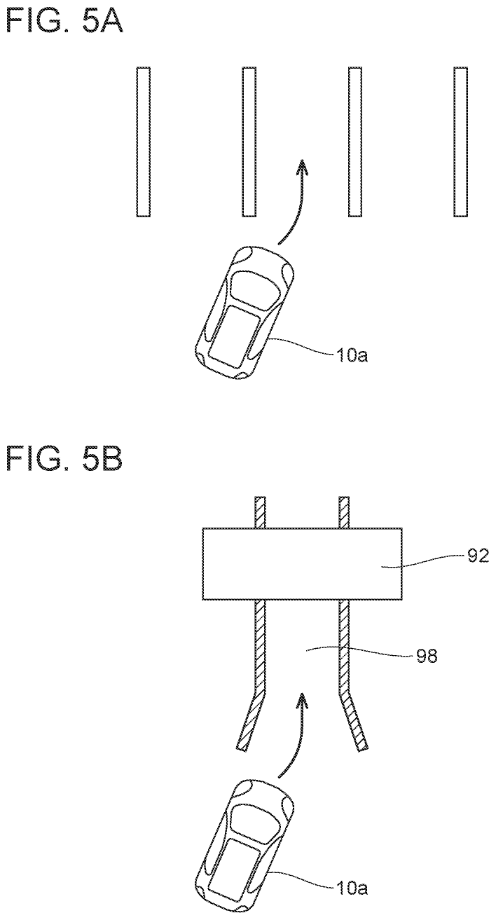

FIG. 5A illustrates a case where the vehicle 10a is to be parked in a typical parking lot. In the typical parking lot, each parking frame is indicated with a paint applied to a road surface. In the typical parking lot, each parking frame is represented by white lines extending linearly and parallel to each other. The width of each white line is relatively wide. The first recognition criterion 42a used in normal times is configured such that the wide white lines extending linearly and parallel to each other are recognized as a parking frame. Therefore, in the automatic parking in normal times, the controller 40 recognizes an area surrounded by the wide white lines extending linearly and parallel to each other as a parking space and parks the vehicle 10a in the recognized parking space.

FIG. 5B illustrates a case where the vehicle 10a is to be parked in the parking space 98 of the vehicle washer 90. The parking frame of the parking space 98 is indicated with metallic rails. The parking frame of the parking space 98 includes linear portions extending parallel to each other, and tapered portions positioned farther from the vehicle washer 90 than the linear portions. The spacing between the tapered portions is increased in a tapered manner. The parking frame of the parking space 98 is colored in yellow or orange. In addition, the width of lines of the parking frame of the parking space 98 is narrow. The second recognition criterion 42b used in moving the vehicle 10a toward/into the vehicle washer 90 is configured such that rails having such a shape, color, and line width are recognized as a parking frame. Therefore, in the automatic parking to the parking space 98 of the vehicle washer 90, the controller 40 recognizes an area surrounded by the above-described rails as a parking space and parks the vehicle 10a in the recognized parking space.

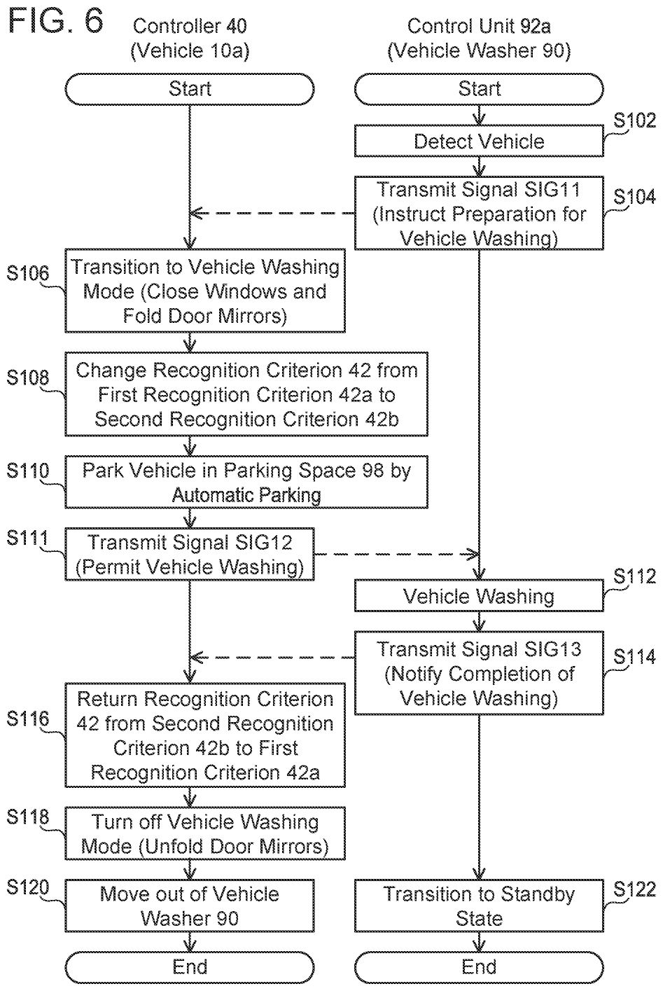

Next, how the vehicle 10a operates when the vehicle 10a is automatically parked in the parking space 98 of the vehicle washer 90 will be described with reference to FIG. 6. As described above, in normal times, the first recognition criterion 42a is set as the recognition criterion 42.

As the vehicle 10a approaches the entrance of the vehicle washer 90, the vehicle washer 90 detects the vehicle 10a by the vehicle sensor (not shown) in step S102 of FIG. 6. Then, in step S104, the control unit 92a transmits, to the controller 40 of the vehicle 10a, a signal SIG11 that instructs preparation for vehicle washing.

The controller 40 of the vehicle 10a, when receiving the signal SIG11, causes the vehicle 10a to transition to a vehicle washing mode in step S106. This vehicle washing mode is the same as that of the first embodiment.

Next, the controller 40 changes the recognition criterion 42 from the first recognition criterion 42a to the second recognition criterion 42b in step S108.

When steps S106, S108 are completed, the controller 40 instructs the driver to move the vehicle 10a into the parking space 98, via a monitor, etc. When the driver performs a predetermined operation, the controller 40 performs automatic parking in step S110. Since the second recognition criterion 42b has been set as the recognition criterion 42 in step S108, the controller 40 appropriately recognizes the parking frame of the vehicle washer 90. Therefore, the vehicle 10a is properly parked in the parking space 98 of the vehicle washer 90 by automatic parking.

Once the vehicle 10a is parked in the parking space 98, the controller 40 transmits a signal SIG12 that permits the start of vehicle washing to the control unit 92a of the vehicle washer 90 in step S111. Then, in step S112, the control unit 92a causes the vehicle washer 90 to perform vehicle washing. When the vehicle washing is completed, the control unit 92a transmits a signal SIG13 that notifies the completion of vehicle washing to the controller 40 of the vehicle 10a in step S114.

When receiving the signal SIG13, the controller 40 of the vehicle 10a changes the recognition criterion 42 from the second recognition criterion 42b to the first recognition criterion 42a in step S116. That is, the controller 40 returns the recognition criterion 42 from the recognition criterion for the vehicle washer to the recognition criterion for normal times.

The controller 40 then turns off the vehicle washing mode in step S118.

As described above, after the vehicle washing is completed, the vehicle 10a returns to the normal traveling mode in steps S116, S118. After that, the driver moves the vehicle 10a out of the vehicle washer 90 in step S120. Then, the vehicle washer 90 detects the movement of the vehicle 10a by the vehicle sensors (not shown) and transitions to the standby status in step S122.

As described above, the vehicle 10a of the second embodiment changes the recognition criterion 42 from the first recognition criterion 42a to the second recognition criterion 42b when moving toward/into the parking space 98 of the vehicle washer 90. Accordingly, the vehicle 10a can be parked in the parking space 98 of the vehicle washer 90 by automatic parking. In addition, the preparation for the vehicle washing is facilitated since the transition to the vehicle washing mode can be implemented in accordance with the change in the recognition criterion 42.

The controller 40 of the second embodiment is an example of automatic parking device.

The embodiments have been described in detail in the above. However, these are only examples and do not limit the claims. The technology described in the claims includes various modifications and changes of the concrete examples represented above. The technical elements explained in the present description or drawings exert technical utility independently or in combination of some of them, and the combination is not limited to one described in the claims as filed. Moreover, the technology exemplified in the present description or drawings achieves a plurality of objects at the same time, and has technical utility by achieving one of such objects.

What is claimed is:

1. A vehicle comprising:
an object sensor configured to detect an object around the vehicle;
a warning device configured to alert a driver when an object is detected by the object sensor at a position at which a distance from the vehicle is less than or equal to a threshold;
a receiver; and
a controller configured to reduce the threshold when the receiver receives a signal transmitted from a vehicle washer.

2. The vehicle of claim 1, further comprising:
a window that is openable; and
a door mirror that is foldable,
wherein the controller is configured to perform a process of closing the window and folding the door mirror when the receiver receives the signal.

3. The vehicle of claim 1, wherein
the object sensor comprises a right object sensor configured to detect an object on a right side of the vehicle and a left object sensor configured to detect an object on a left side of the vehicle, and
the warning device comprises a display device configured to display, when an object is detected by the object sensor, whether the detected object is present on the left side or the right side of the vehicle.

4. A vehicle comprising:
a camera configured to capture an image of a road surface around the vehicle;
an automatic parking device configured to recognize a parking frame from the image captured by the camera according to a recognition criterion and move the vehicle into the recognized parking frame;
a receiver; and
a controller configured to change the recognition criterion when the receiver receives a signal transmitted from a vehicle washer.

5. The vehicle of claim 4, further comprising:
a window that is openable; and
a door mirror that is foldable,
wherein the controller is configured to perform a process of closing the window and folding the door mirror when the receiver receives the signal.
